(19) United States
(12) Patent Application Publication
(10) Pub. No.: US 2022/0230509 A1
(43) Pub. Date: Jul. 21, 2022

(54) GAMING DEVICES AND METHODS FOR OPERATING GAMING DEVICES HAVING ANTICIPATORY EXPANDED GAME GRIDS

(71) Applicant: KING SHOW GAMES, INC., Minnetonka, MN (US)

(72) Inventor: Christopher RODRIGUEZ, Saint Louis Park, MN (US)

(21) Appl. No.: 17/580,637

(22) Filed: Jan. 20, 2022

Related U.S. Application Data
(60) Provisional application No. 63/139,777, filed on Jan. 20, 2021.

(51) Int. Cl. G07F 17/32

(52) U.S. Cl. CPC G07F 17/3267; G07F 17/3211

(57) ABSTRACT

Embodiments of the present invention set forth systems, apparatuses and methods for implementing anticipatory expanded game grids. Accordingly, a gaming device can be configured to include a video display configured to show a game grid having an initial size with number of columns and rows. When a certain triggering element is received in the game grid, non-active extended symbol positions are revealed above (or below) the game grid. These non-active extended symbol positions are maintained over the course of multiple gaming events until they reach the edge of the initial game grid. On a subsequent gaming event, these non-active extended bonus symbol positions thereafter become active and are used in the evaluation of the now extended game grid for at least this subsequent game.

### RELATED APPLICATIONS

This application claims the benefit of Provisional Patent Application No. 63/139,777, filed on Jan. 20, 2021, to which priority is claimed pursuant to 35 U.S.C. § 119(e) and which is incorporated herein by reference in its entirety.

### FIELD OF THE INVENTION

This disclosure relates generally to games, and more particularly to systems, apparatuses and methods for providing improved gaming devices with anticipatory expanding game grids.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate implementing an expanded game grid feature that has a state-based reveal to build anticipation. In one embodiment, a gaming device includes a video display configured to show a game grid having an initial size with number of columns (e.g., reels) and rows. When a certain triggering element is received in the game grid, non-active extended symbol positions are revealed above (or below) the game grid. These non-active extended symbol positions are maintained over the course of multiple gaming events until they reach the edge of the initial game grid. On the next gaming event after the non-active extended symbol positions reach the edge of the initial game grid, these non-active extended bonus symbol positions become active and are used in the evaluation of the now extended game grid for at least this next game.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention

FIG. 3 is a diagram showing a game progression according to embodiments of the invention.

FIGS. 4A-4O are images showing another game progression according to embodiments of the invention.

FIG. 5A is a block diagram showing a representation of a game grid having an anticipatory grid expanding feature according to embodiments of the invention.

FIG. 5B is a diagram showing a game grid having an anticipatory grid expanding feature according to embodiments of the invention.

FIGS. 6A-6D are diagrams of a game grid showing another game progression according to embodiments of the invention.

FIG. 7 is a diagram showing a game grid having an anticipatory grid expanding feature with modifier symbols having an anticipatory grid expanding feature.

FIG. 8 is a flow diagram showing a method of operating a gaming device having an anticipatory grid expanding feature having an anticipatory grid expanding feature.

FIG. 9 is a block diagram showing a representation of a game grid in video poker with an anticipatory grid expanding feature according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for implementing an expanded game grid feature that has a state-based reveal to build anticipation. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of implementing an expanded game grid feature that has a state-based reveal to build anticipation. In one embodiment, a gaming device includes a video display configured to show a game grid having an initial size with number of columns (e.g., reels) and rows. When a certain triggering element is received in the game grid, non-active extended symbol positions are revealed above (or below) the game grid. These non-active extended symbol positions are maintained over the course of multiple gaming events until they reach the edge of the initial game grid. On the next gaming event after the non-active extended symbol positions reach the edge of the initial game grid, these non-active extended bonus symbol positions become active and are used in the evaluation of the now extended game grid for at least this next game.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

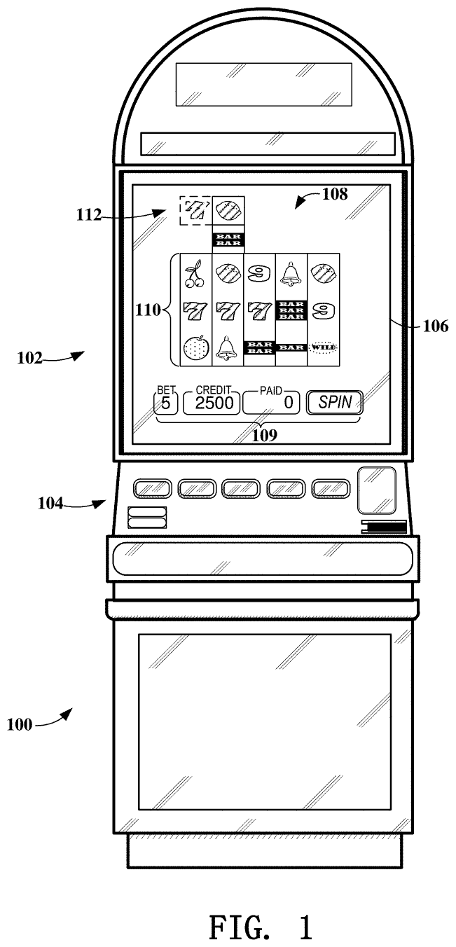

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, a secondary display portion 112, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

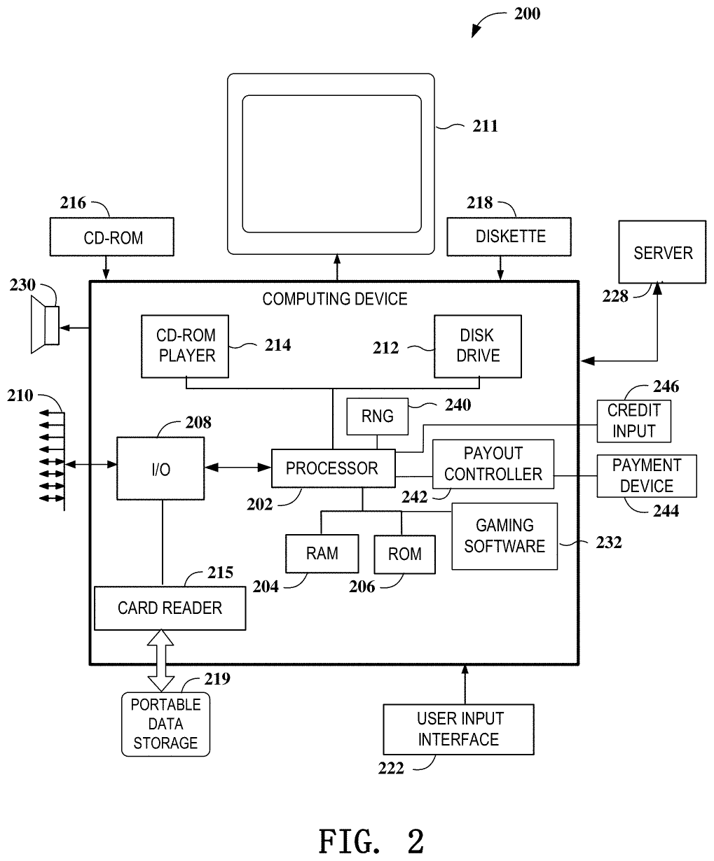

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

The secondary display portion 112 may include space for extra symbol positions to be revealed upon a trigger condition. These extra (or bonus) symbol positions may be initially inactive (although they may show symbols from corresponding reel strips) and not influence the outcome of game events. However, as more trigger conditions are satisfied, additional bonus symbol positions may be revealed below the initial extra symbol position until the bonus symbol positions reach the main symbol or game grid 110. When the bonus symbol positions in the secondary display portion 112 reaches the game grid 110, the associated bonus symbol positions may become active for the next game or for a number of subsequent games where symbols that are displayed in these bonus symbol positions are evaluated with the rest of the main game grid 110 in determining prizes to award.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

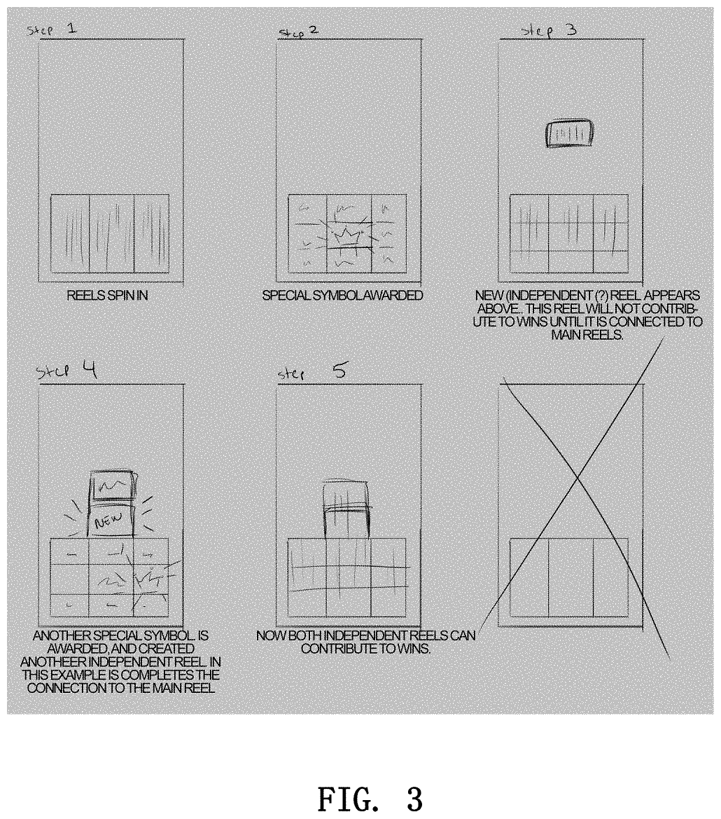

FIG. 3 is a diagram showing a game progression according to embodiments of the invention. As shown in FIG. 3 the game progression may start with a reel spin in step 1. When the reels stop spinning in step 2, the gaming device determines that a special symbol (or subsymbol overlay, or other triggering condition in other embodiments) is received. When such trigger condition is satisfied, an inactive symbol position is revealed above the reel where the trigger condition was satisfied as shown in step 3, although in other embodiments the inactive symbol position may be revealed above or below reels where the trigger condition did not occur. When these bonus symbol positions are revealed, they do not necessarily evaluated to determine game event awards; however, they may show symbols that are spinning by, where such symbols may be part of the reel associated with the grid column with which it is associated, or the symbols shown may be from an independent game reel.

As shown in step 4, when enough of these bonus symbol positions are triggered and revealed to reach or connect to the main game grid, the bonus symbol positions become active for at least the next spin or a number of future game events. As shown in step 5, the bonus symbol positions will now have symbols that are used in evaluating awards. These evaluations may use predetermined paylines, or may be based on different ways or combinations of symbols that appear anywhere on consecutive reels (such as a multiple-way evaluation technique). Hence, the additional active bonus symbol positions may lead to an increased chance of receiving a winning combination or a larger winning combination associated with a larger prize than if the main game grid was evaluated by itself. Additionally as it may take multiple games to satisfy the trigger condition enough times to have the bonus symbol positions connect to the main game grid and become active, there is an anticipation element associated with the player seeing how close they are to activating these additional reel positions for better chances at large winning outcomes and awards.

In some embodiments, a gaming device includes a video display configured to show a game grid having an initial size with number of reels (columns) and rows. When a certain triggering element is received in the game grid, non-active extended symbol positions are revealed above (or below) the game grid. These non-active extended symbol positions are maintained over the course of multiple gaming events until they reach the edge of the initial game grid. On the next gaming event after the non-active extended symbol positions reach the edge of the initial game grid, these non-active extended bonus symbol positions become active and are used in the evaluation of the now extended game grid for at least this next game.

That is, in these embodiments a secondary display portion may include space for extra symbol positions to be revealed upon a trigger condition. These extra (or bonus) symbol positions may be initially inactive (although they may show symbols from corresponding reel strips) and not influence the outcome of game events. However, as more trigger conditions are satisfied, additional bonus symbol positions may be revealed below the initial extra symbol position until the bonus symbol positions reach the main symbol or game grid. When the bonus symbol positions in the secondary display portion reach the game grid, the associated bonus symbol positions may become active for the next game or for a number of subsequent games where symbols that are displayed in these bonus symbol positions are evaluated with the rest of the main game grid in determining prizes to award.

In some embodiments, the inactive bonus symbol positions may not show any symbols during game events until they are activated. In other embodiments, these inactive bonus symbol positions may show game symbols from the game reel that is associated with underlying column in the main game grid. That is, for example, if the inactive symbol positions were located above the third game reel, symbols from the third game reel may be seen passing through the inactive symbol positions when the reels spin and may show game symbols that are positionally related on the third game reel when the reels stop to show a gaming event outcome—even though these symbols in the inactive bonus symbol positions will not be evaluated for awards in the game event. In yet other embodiments, independent reels may be individually used in each (or for each column) revealed bonus symbol position in either or both cases when the bonus symbol positions are inactive or when they are active.

In some embodiments, other modifiers may be associated with the revealed bonus symbol positions. For example, multipliers may be associated with some or all of the revealed bonus symbol positions. In other examples, multi-symbols may be associated with some or all of the revealed bonus symbol positions, whereby symbols landing in those positions are doubled to count as two or more symbols. In yet other examples, some of the revealed bonus symbol positions may be associated with credit values that are won when the symbol positions connect to the main game grid and become active. Many additional modifiers may also be used with some or all of the game reels associated with the revealed bonus symbol positions.

In some embodiments, these modifiers may be randomly selected when the bonus symbol position is activated, while in other embodiments, the modifier may be associated with the triggering condition. For example, if subsymbol overlays are used to determine if and how many bonus symbol positions are revealed, the type subsymbol overlay received may determine the modifier associated with the revealed bonus symbol position. Alternatively, the value or type of modifier may be randomly shown on the subsymbol overlay. For example, random credit or progressive values may be associated with the subsymbol overlays that are received on the main game grid, which then may be transferred to the associated revealed bonus symbol position.

In some embodiments, the inactive bonus symbol positions may become active based on a triggering condition other than the bonus symbol positions reaching or touching the main game grid. For example, the inactive bonus symbol positions may become active after a certain number of games or spins after they are revealed. In another example, a different type of subsymbol overlay or other triggering condition may cause any inactive bonus symbol position to become active for the next game or next series of games. In these examples, a variety of evaluation techniques may be used to determine payouts for game results where there are active bonus symbol positions that are not connected to the primary game grid. These evaluation techniques may rely on additional paylines or multiple-ways as discussed herein.

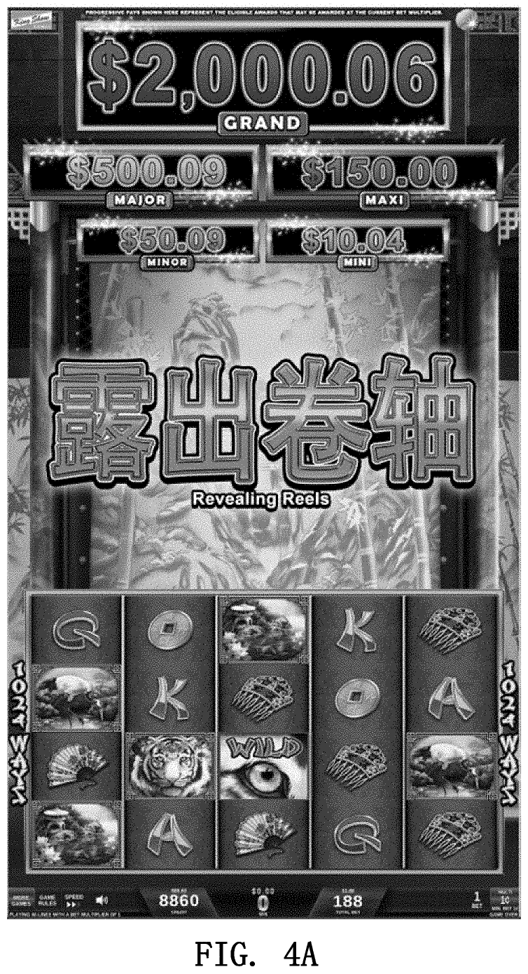

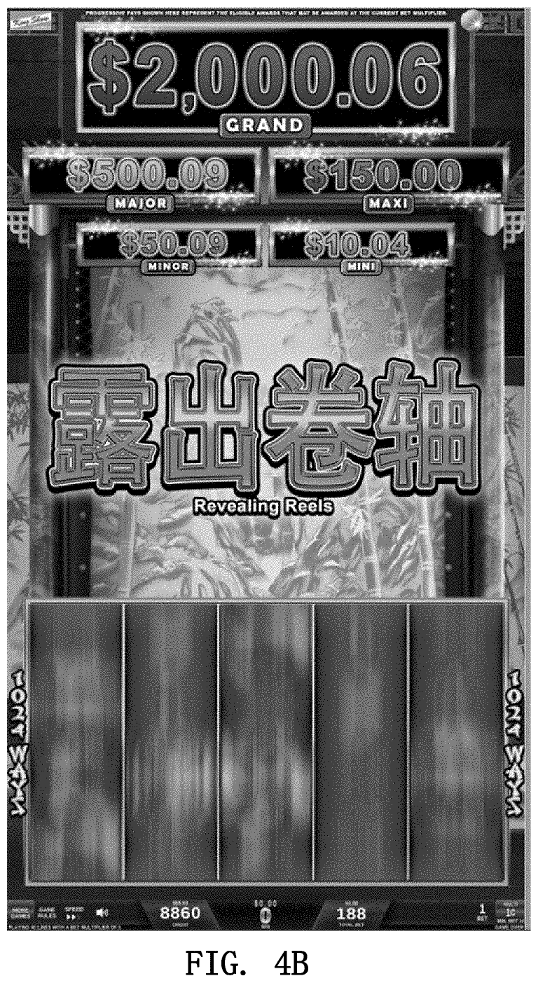

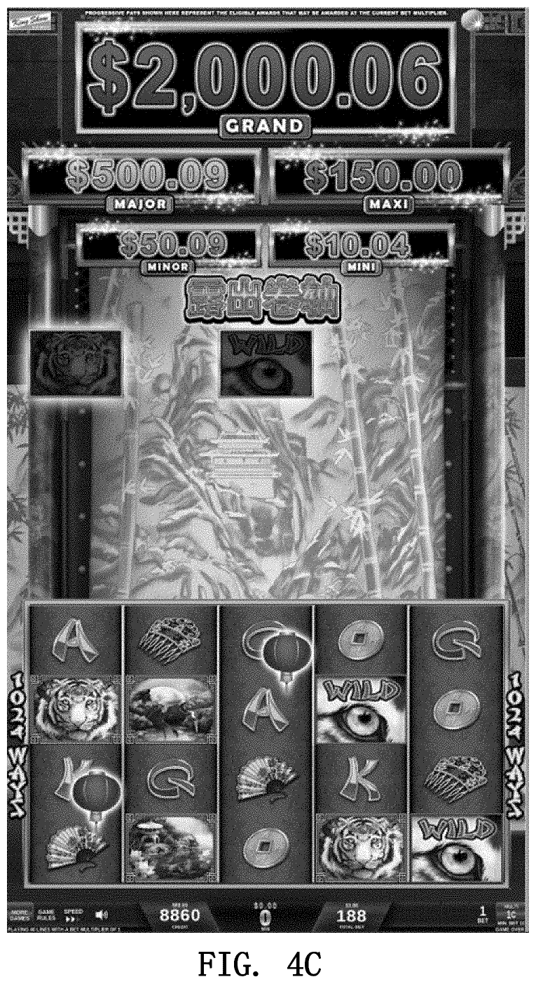

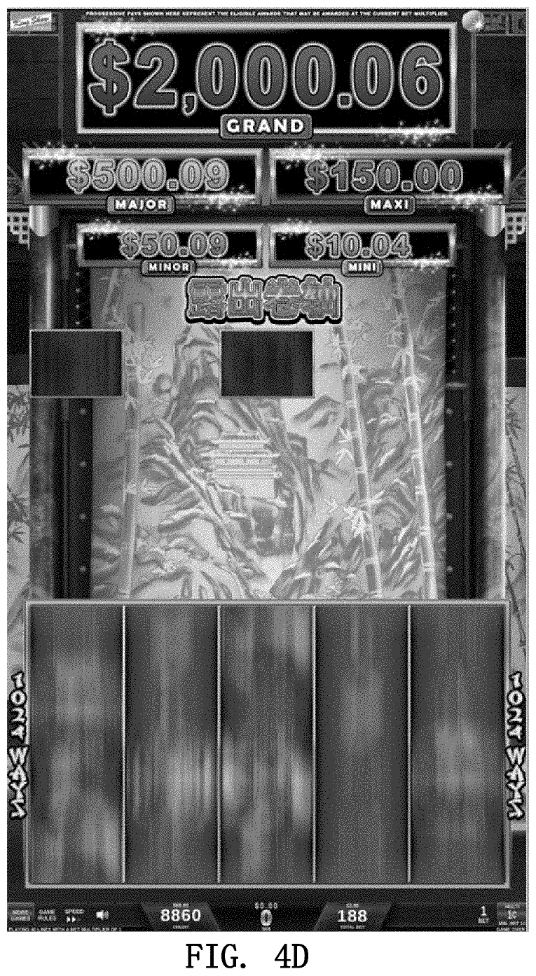

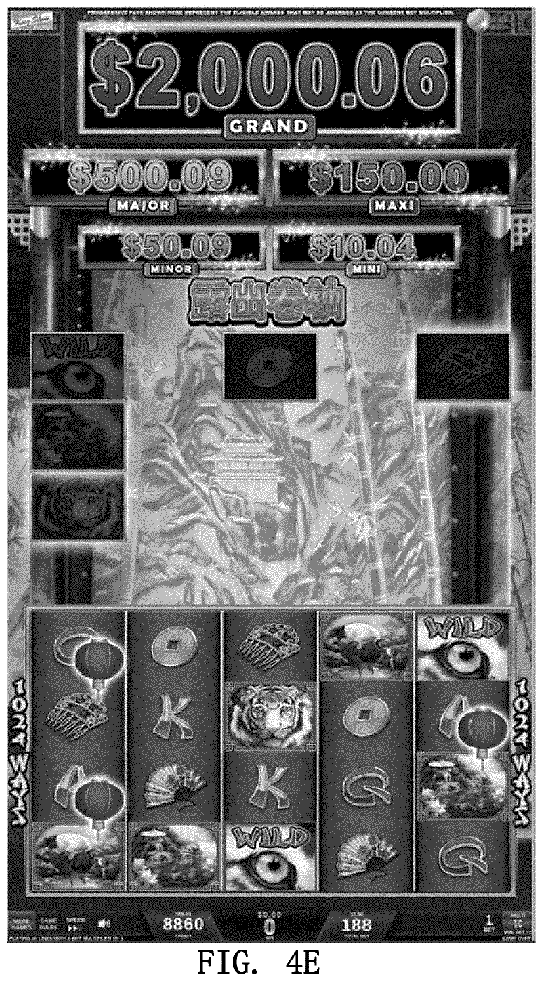

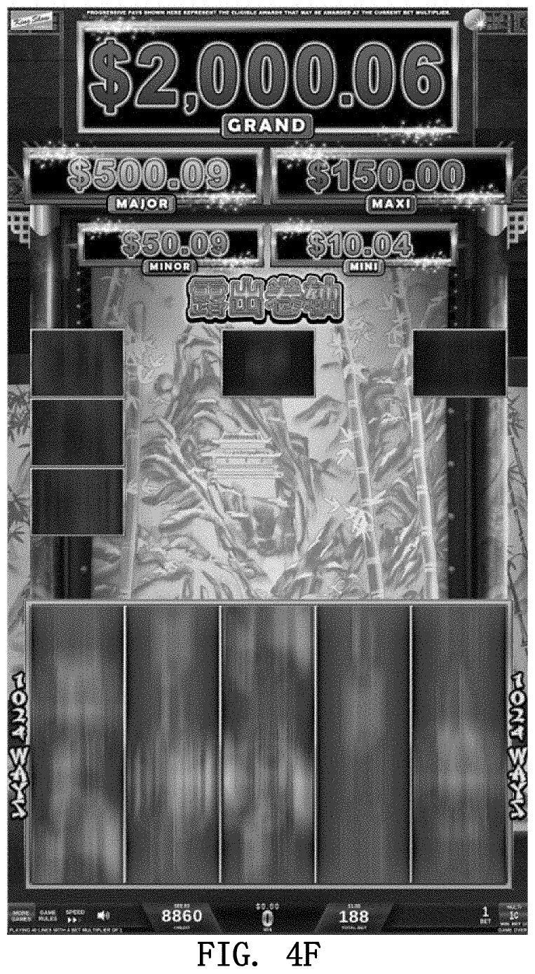

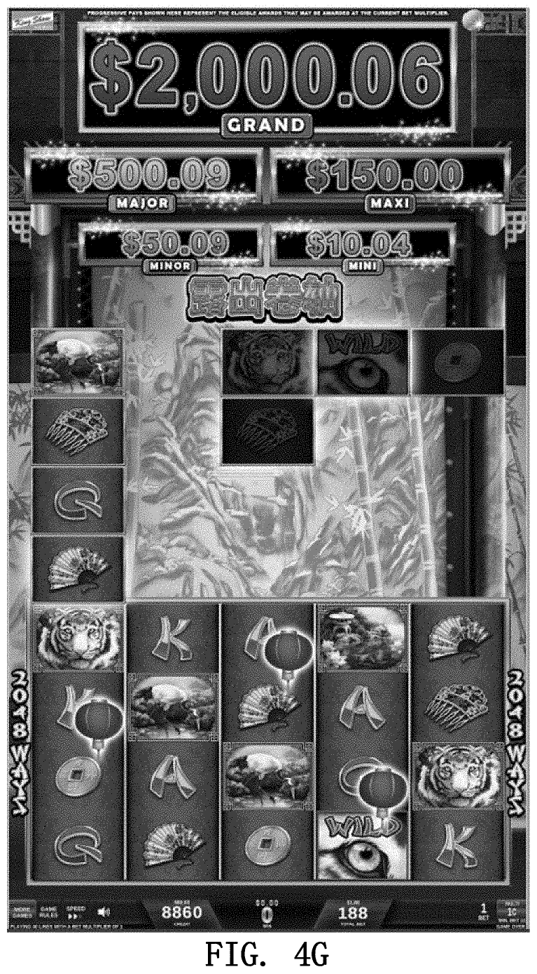

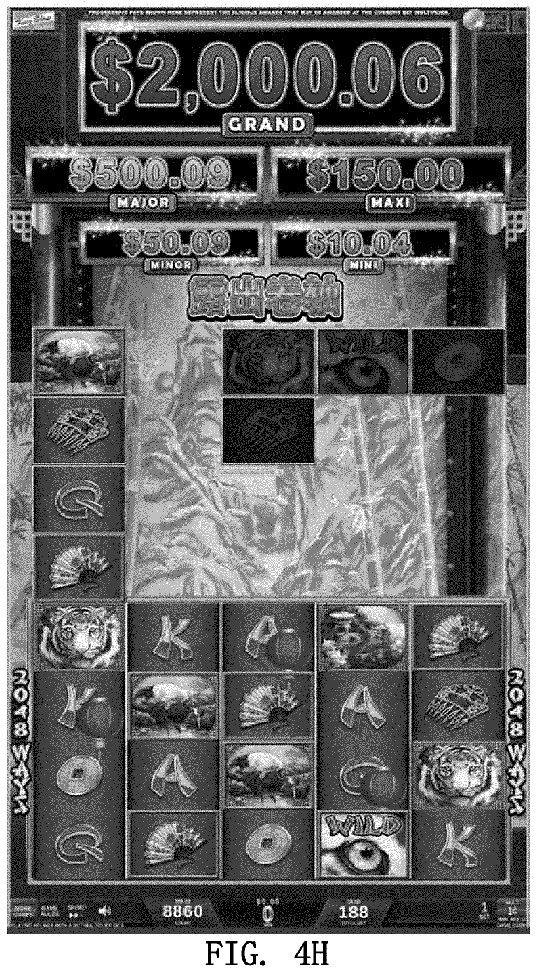

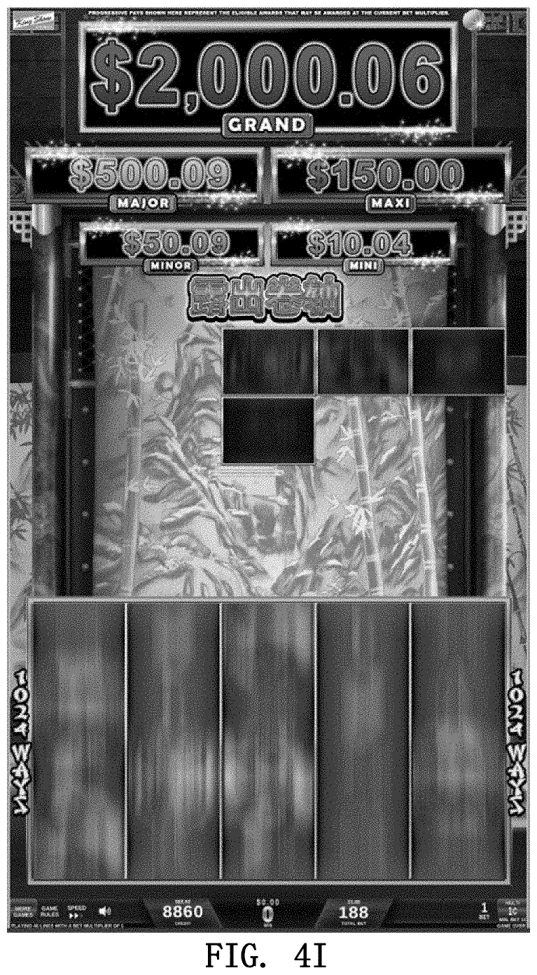

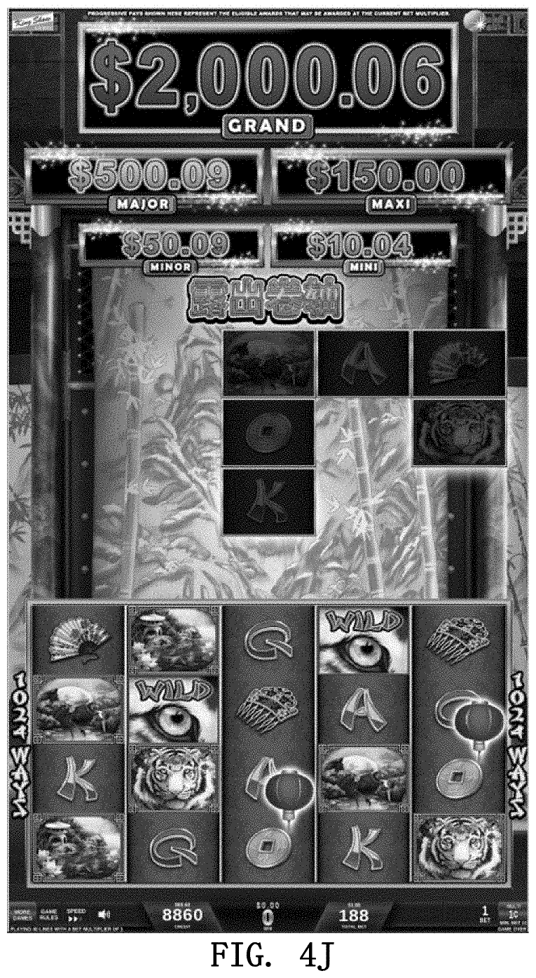

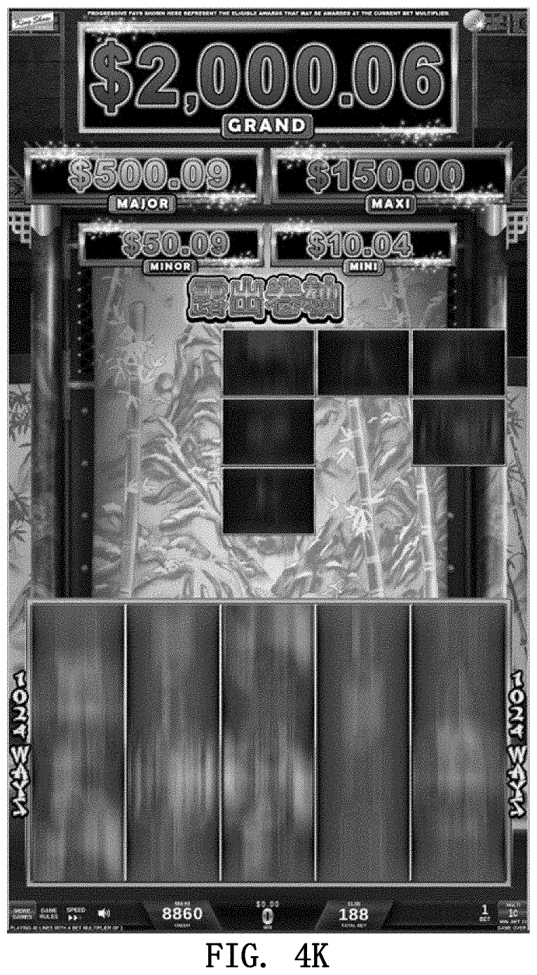

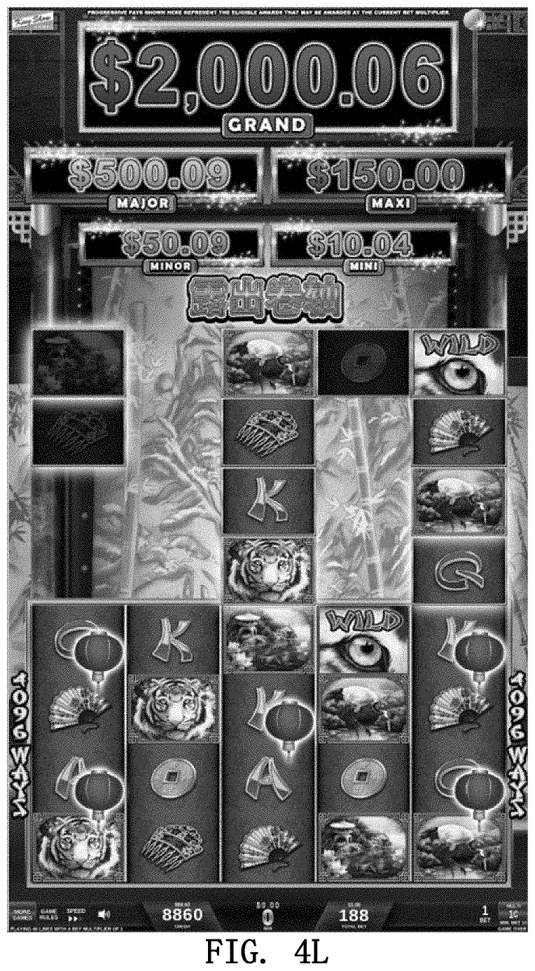

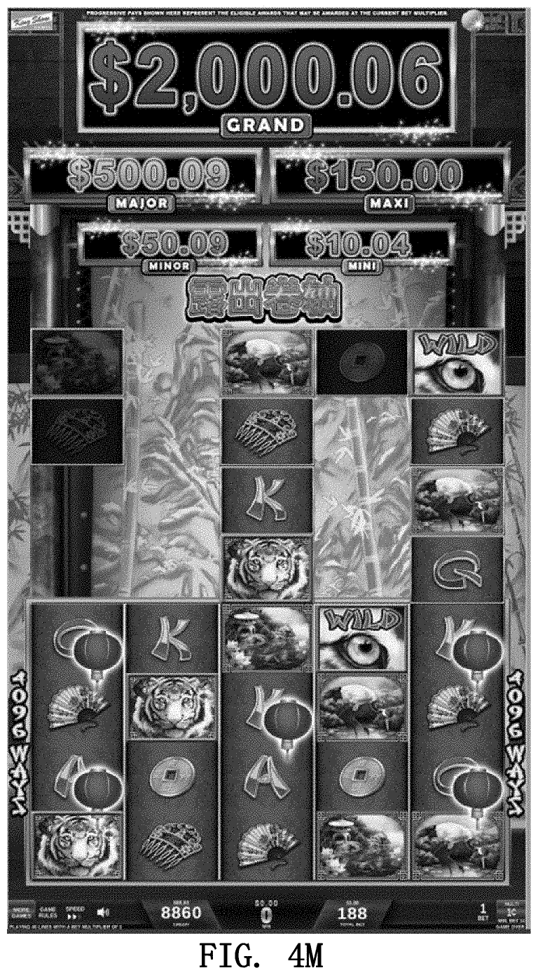

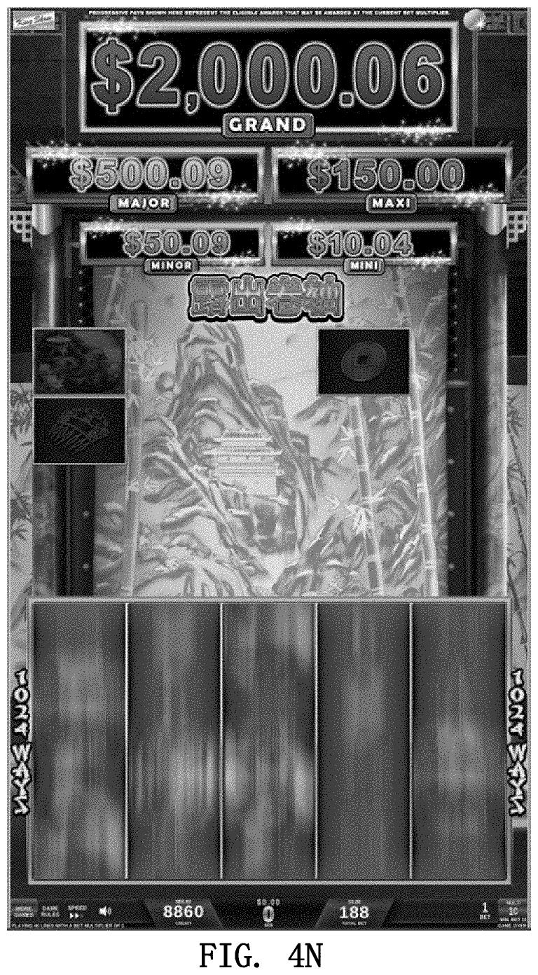

FIGS. 4A-4O are images showing another game progression according to embodiments of the invention. Here, 4A shows an initial game grid, which is spun in FIG. 4B. In 4C, subsymbol overlays on reels 1 and 3 (in this example, red balloon subsymbol overlays) result in bonus symbol positions being revealed in an inactive state. In FIG. 4D, the next game event is spun resulting in a game outcome shown in FIG. 4E where two more subsymbol overlays are received on the first reel and one triggering subsymbol overlay is received on reel 5. In FIG. 4F, the next game event is spun resulting in a game outcome shown in FIG. 4G, where a triggering subsymbol overlay is received on reel 4, and another triggering subsymbol is received on the first reel, which causes the bonus symbol positions in the first reel to become active and used in the evaluation of the game outcome as shown in FIG. 4H. In FIG. 4I, the next game even is spun—note that the bonus symbol positions in the first reel have reset while the revealed bonus symbol positions that were inactive on reels 3, 4, and 5 are maintained. This sequence is continued in FIG. 4J where bonus symbol positions are revealed on reels 3 and 5. The reels are spun again in FIG. 4K, and bonus symbol positions are revealed on reels 1 (two bonus symbol positions corresponding to the two subsymbol overlays received on reel 1), 3 and 5 (again with two bonus symbol positions being revealed). Here, as the bonus symbol positions on reels 3 and 5 reach the primary game grid, the bonus symbol positions on reels 3 and 5 are activated. In FIG. 4M, the game grid with the now activated bonus symbol positions on reels 3 and 5 are evaluated for winning symbol combinations. In FIG. 4N, the next game is triggered and the symbol positions on reels 3 and 5 are reset while the inactive symbol positions on reels 1 and 4 are maintained. In FIG. 4O, yet another subsymbol overlay is received on reel 1, causing another bonus subsymbol position above reel 1 to be revealed.

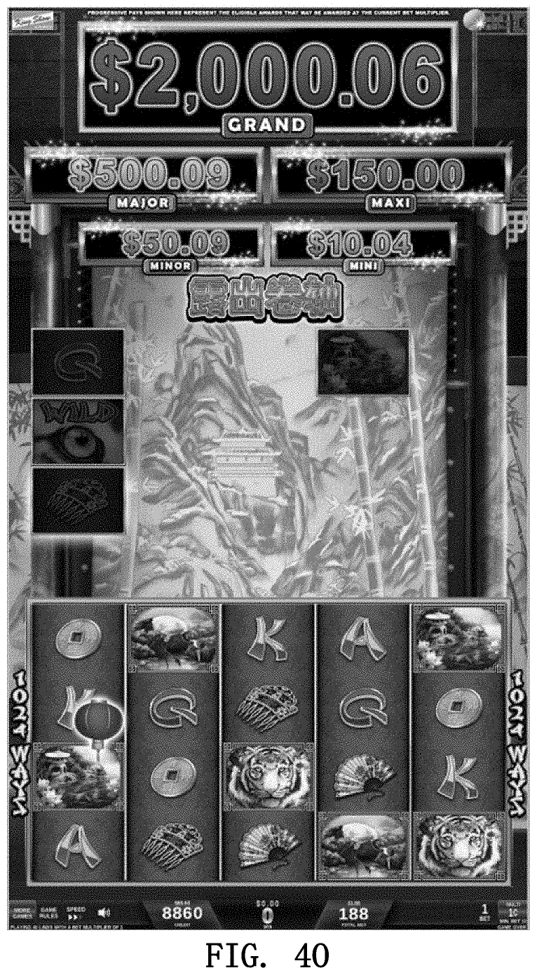

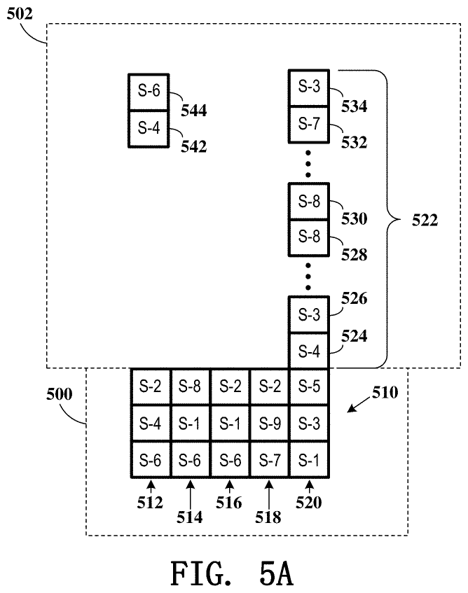

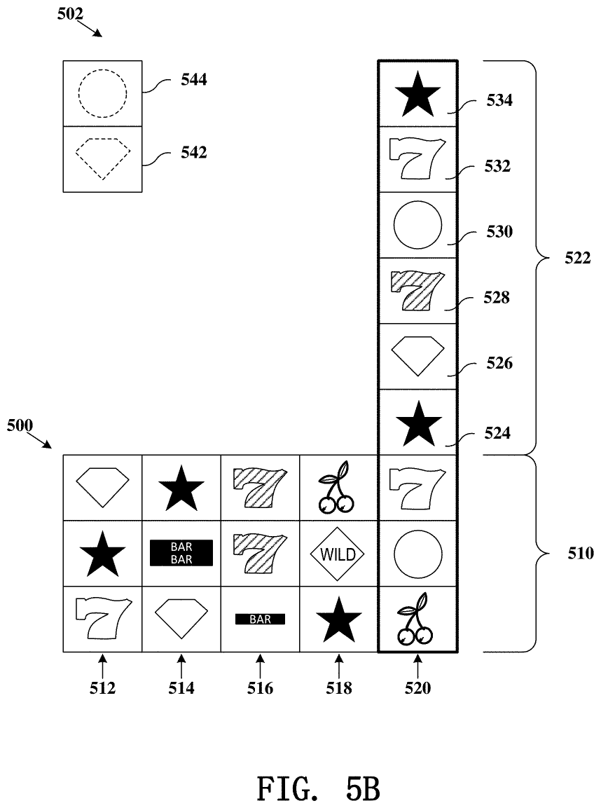

FIG. 5A is a block diagram showing a representation of a game grid having an anticipatory grid expanding feature according to embodiments of the invention. FIG. 5B is a diagram showing a game grid having an anticipatory grid expanding feature according to embodiments of the invention. FIGS. 5A and 5B show in part that any number of bonus symbol positions may be used in a secondary display area above (or below) the main game grid. Referring to FIGS. 5A and 5B, a primary game grid 510 and a secondary game grid (or bonus game area) 522 are shown in a respective first portion 500 of a game display and a second portion 502 of the game display. In some embodiments, the first portion 500 and second portion 502 of the game display may be shown on a single common video display device, while in other embodiments, the first portion 500 of the game display may be shown on a first video display device and the second portion 502 of the game display may be shown on a second video display device. In this example embodiment, the primary game grid 510 is associated with five columns 512, 514, 516, 518, 520 of showing portions of a plurality of game reels. Here, the game reels may be single game reels that extend through both the primary game grid 510 and the secondary game grid 522. In alternative embodiments, each symbol position in both the primary game grid 510 and the secondary game grid 522 may be independent game reels that are respectively associated with each individual symbol position in the primary and second game grids. In yet other embodiments, continuous game reels (or dependent game reels) may pass through each column 512, 514, 516, 518, 520 in the primary game grid 510 while independent game reels may be used with each symbol position 524, 526, 528, 530, 532, 534, 542, 544 in the secondary game grid.

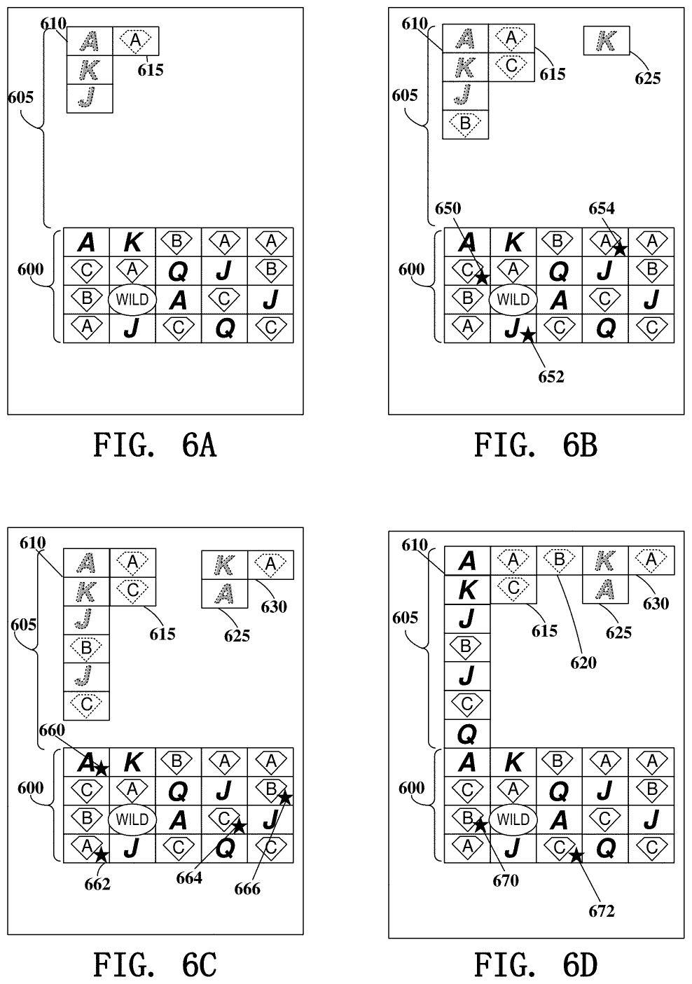

FIGS. 6A-6D are diagrams of a game grid showing another game progression according to embodiments of the invention. Here, the triggering condition is the receipt of star subsymbol overlays as shown in FIGS. 6A-6D. Referring to FIG. 6A a primary game grid 600 and secondary game grid 605 are shown on a game display of a gaming device, where a first reel 610 and a second reel 615 of the secondary game grid have existing inactive symbol positions. Referring to FIG. 6B, another game is played and star subsymbols 650, 652, 654 are received in the primary game grid 600. Based on receiving these star subsymbols 650, 652, 654, new symbol positions are revealed in the secondary game grid on bonus reels 610, 615, 625, all of which remain inactive. Referring to FIG. 6C, another game is played and star subsymbols 660, 662, 664, 666 are received in the primary game grid 600. Based on receiving these star subsymbols 660, 662, 664, 666, new symbol positions are revealed in the secondary game grid on bonus reels 610 (two of them), 625, 630, which again remain inactive. Referring to FIG. 6D, another game is played and star subsymbols 670, 672 are received in the primary game grid 600. Based on receiving these star subsymbols 670, 672, new symbol positions are revealed in the secondary game grid on bonus reels 610, 620. While some of the bonus reels 615, 620, 625, 630 remain inactive here, the first bonus reel 610 reaches the primary game grid 600 and becomes active for this game and in some embodiments may remain active for a series of subsequent games.

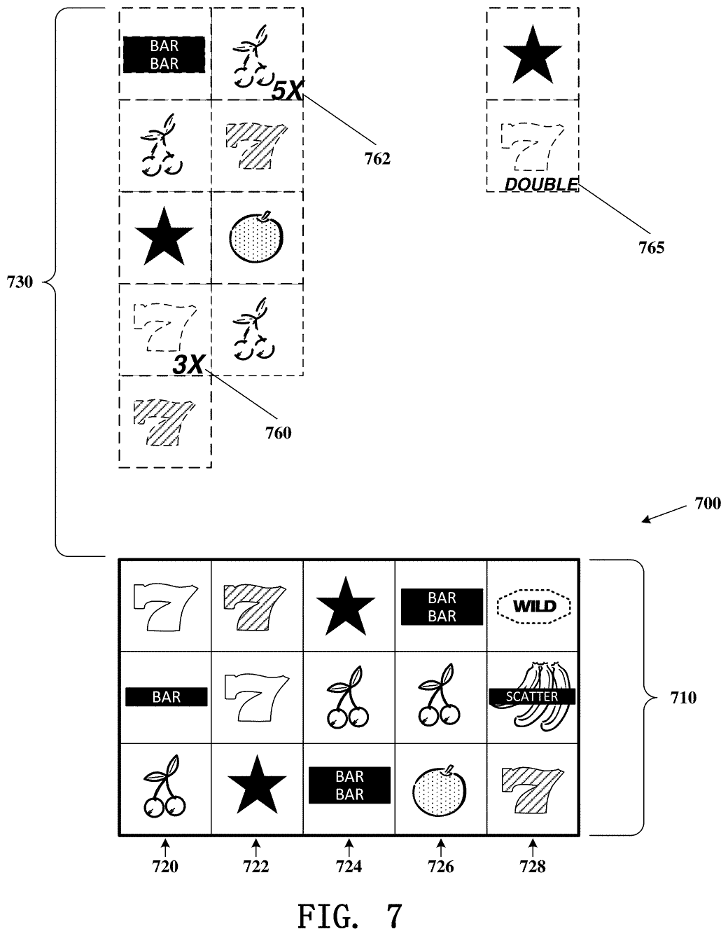

FIG. 7 is a diagram showing a game grid having an anticipatory grid expanding feature with modifier symbols having an anticipatory grid expanding feature. FIG. 7 illustrates that modifiers may be associated with some (or all) of the bonus symbol positions that are revealed in the secondary display portion. Referring to FIG. 7, a primary game grid 710 includes five columns 720, 722, 724, 726, 728 respectively associated with game reels, and a secondary game grid 730 are shown on a single game display 700. Here, the secondary game grid 730 includes independent game reels associated with each bonus symbol position that is revealed (whether inactive or active). Each of the independent game reels associated with the bonus symbol positions in the secondary game grid 730 have enhanced reel strips with at least some symbols including bonus modifiers, such as multipliers 760, 762, multiple symbols 765 in a single symbol position, and/or additional wild symbols or bonus symbols (not shown). These enhanced reel strips make connecting the bonus reels in the secondary game grid 730 to the primary game grid (or otherwise making these bonus symbol positions active) especially attractive to a player as these symbol modifiers can lead to large winning combinations and awards.

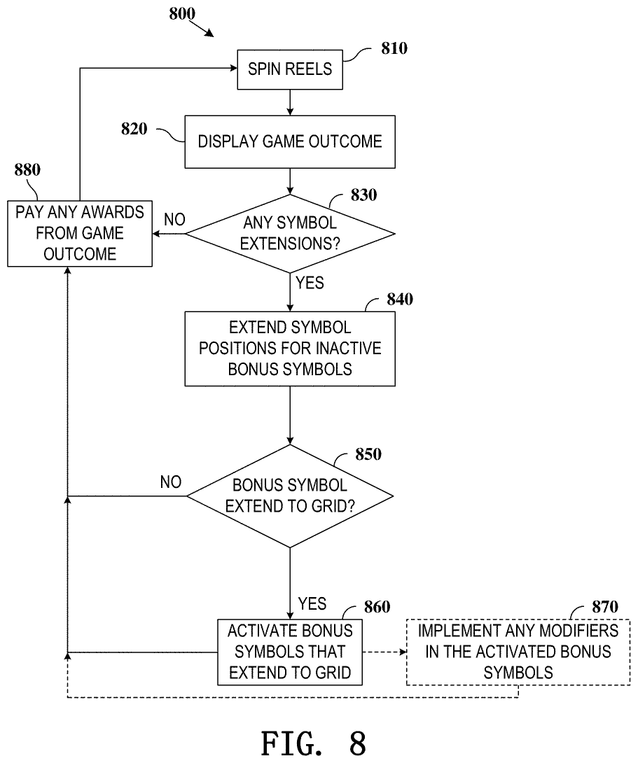

FIG. 8 is a flow diagram showing a method of operating a gaming device having an anticipatory grid expanding feature having an anticipatory grid expanding feature.

FIG. 8 and any other diagrams depicting a process flow represent operations in which a gaming device and/or gaming system can be operated according to representative embodiments. Although various processes may be depicted in a particular order, the order of these operations can be changed in other embodiments without deviating from the scope or spirit of this concept. Accordingly, the order of the processes shown is for illustrative purposes only and is not meant to be restrictive. Additional game processes may also be included between various processes even though they are not shown in these operational processes for purposes of clarity. The operations or processes may be performed by components in a single game device, such as by a game processor(s), or may be performed in part or whole by a remote server or processor(s) connected to the gaming device via a network. Each operation or process may be encoded in instructions that are stored in one or more memories, a computer-readable medium(s), or another type of storage device(s). The exemplary operations and methodologies depict representative embodiments of how game operations may be implemented. As discussed herein, many variations exist which may require additional, fewer, or different processes to complete.

Referring to FIG. 8, flow 800 begins at process 810 where a base game is initiated and the game reels of the game are spun. In process 820, the reels are stopped and the game outcome is displayed. In process 830, a game processor determines if any triggering conditions are received to cause symbol extensions (symbol positions being revealed) in a bonus or secondary game portion. If no symbol extensions are triggered, flow 800 proceeds to process 880 where the game outcome is evaluated and any determined awards are provided to the player. If one or more symbol extension is triggered as determined in process 830, process 800 proceeds to process 840 where symbol positions in the bonus game portion are revealed (e.g., extended toward a primary game grid). In process 850 it is determined if the revealing the bonus symbol position in process 840 has resulted in one or more of the bonus game reels in the bonus game portion extending to the primary game grid (or otherwise triggering the activation of at least some of the bonus symbol positions in the bonus game portion). If there has not been a triggering event to activate the bonus symbol positions, flow 800 returns to process 880 as described above. If a triggering condition has been satisfied, however, as determined in process 850, flow 800 proceeds to process 860 where the corresponding bonus symbol positions are activated. Here, an optional process 870 may follow process 860 where modifiers associated with the activated bonus symbol positions are implemented (i.e., applied). In either case, process 800 then proceeds to process 880 to evaluate the primary game grid and activated portion of the bonus game grid to determine awards to be provided to the player.

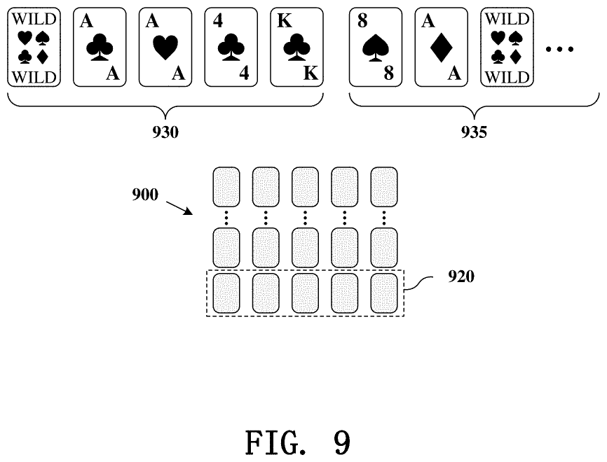

FIG. 9 is a block diagram showing a representation of a game grid in video poker with an anticipatory grid expanding feature according to embodiments of the invention. Here, it is shown that embodiments of the invention may be implemented in video poker game. For example, bonus card positions may be revealed 930, 935 above a single poker hand main game (or a multiple poker hand main game as shown in FIG. 9) 900 that could be used to provide extra cards for evaluation purposes or modifiers for the underlaying base poker games. In embodiments, utilizing multiple poker hands, each poker hand 920 may be associated with different bonus hands 930 in a bonus display portion. Here, individual card positions may be shown as inactive card positions until 5 bonus card positions are revealed, at which point an additional poker hand may be received in the bonus card positions. This bonus poker hand may have cards automatically held to it from a primary poker game (such as how a multi-hand poker game is typically played), or may have a bonus hand simply dealt to it independently of any primary poker hand(s) in the poker game.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out herein.

1. A gaming device comprising:
a game display having a first game grid of symbol positions and a second game grid of symbol positions;
a wager input device structured to receive physical currency or currency-based tickets, the currency or currency-based tickets establishing a credit balance, the credit balance being increasable or decreasable based at least on wagering activity; and
a processor configured to:
receive a signal to initiate a game of chance in response to placement of a wager, the wager decreasing the credit balance;
determine a first game outcome to display on the first game grid;
determine if a bonus subsymbol overlay appears in the first game grid;
reveal an inactive symbol position in the second game grid corresponding to the received bonus subsymbol overlay in the first game grid;
determine if a triggering condition has been received to activate at least some of the symbol positions in the second game grid;
evaluate the first game grid and the second game grid for symbol combinations associated with awards; and
provide any awards from the evaluation, where the provided awards increase the credit balance.
